(19) United States
(12) Patent Application Publication
(10) Pub. No.: US 2012/0049030 A1
(43) Pub. Date: Mar. 1, 2012

(54) Portable holding device

(76) Inventor: Kevin Alan Tussy, Las Vegas, NV (US)

(21) Appl. No.: 12/806,936

(22) Filed: Aug. 24, 2010

(51) Int. Cl. A47G 29/00; F16M 13/00

(52) U.S. Cl. 248/311.2; 248/309.1

(57) ABSTRACT

A holding device comprising a holder designed to hold an object such as a beverage container, a tray extending laterally outward from the bottom of holder, and a stabilizing member extending downward from the holder and tray. In various exemplary embodiments, the beverage container is a mug with a handle, a soda can, or any other form of beverage container. In one embodiment the stabilizing member extends downward perpendicular to the plane of the bottom of the holder, and the surface of said stabilizing member may be textured. The stabilizing member may have removable extensions, and may extend downward from the middle of the holder or from one edge of the holder. The tray may be completely or partially removable.

### BACKGROUND OF THE INVENTION

1. Field of the Invention

The invention relates generally to the field of portable holding devices. In particular, the invention relates to portable holding devices for beverage containers and other objects.

2. Description of Related Art

The prior art includes a wide variety of portable holding devices for beverage containers and other objects that can be clipped or attached to various objects of a particular shape or size. However, the prior art has failed to address the problem of providing a portable holder for beverage containers and other objects that is stable when used on moveable surfaces, particularly common household furnishings such as sofas and chairs that have one or more upholstered cushions.

The present invention overcomes this problem, providing a simple, portable device for securely holding beverage and other containers, as well as other objects, on such moveable surfaces.

### SUMMARY OF THE INVENTION

A holding device comprising a holder designed to hold a beverage container, a tray extending laterally outward from the bottom of holder, and a stabilizing member extending downward from the holder and tray. In various exemplary embodiments, the beverage container is a mug with a handle, a soda can, or any other form of beverage container. In one embodiment the stabilizing member extends downward perpendicular to the plane of the bottom of the holder, and the surface of said stabilizing member may be textured. The stabilizing member may have removable extensions, and may extend downward from the middle of the holder or from one edge of the holder. The tray may be completely or partially removable.

A holding device comprising a holder designed to hold one or more objects, and a stabilizing member extending downward from the holder. In various exemplary embodiments, the object may be a beverage container, a soda can, or any other object.

### BRIEF DESCRIPTION OF THE DRAWINGS

FIG. 1 is a diagram showing a top perspective view of an exemplary portable holding device.

FIG. 2 is a diagram showing a side view of an exemplary portable holding device.

FIG. 3 is a diagram showing an alternate side view of an exemplary portable holding device.

FIG. 4 is a diagram showing a further alternate side view of an exemplary portable holding device.

FIG. 5 is a diagram showing a plan view of an exemplary portable holding device.

FIG. 6 is a diagram showing a bottom view of an exemplary portable holding device.

FIG. 7 is a diagram showing a top perspective view of an exemplary portable holding device.

FIG. 8 is a diagram showing an exemplary portable holding device in use on a sofa.

### DETAILED DESCRIPTION OF THE PREFERRED EMBODIMENTS

The following description is presented to enable any person skilled in the art to make and use the invention. For purposes of explanation, specific nomenclature is set forth to provide a thorough understanding of the present invention. Descriptions of specific embodiments or applications are provided only as examples. Various modifications to the embodiments will be readily apparent to those skilled in the art, and general principles defined herein may be applied to other embodiments and applications without departing from the spirit and scope of the invention. Thus, the present invention is not intended to be limited to the embodiments shown, but is to be accorded the widest possible scope consistent with the principles and features disclosed herein.

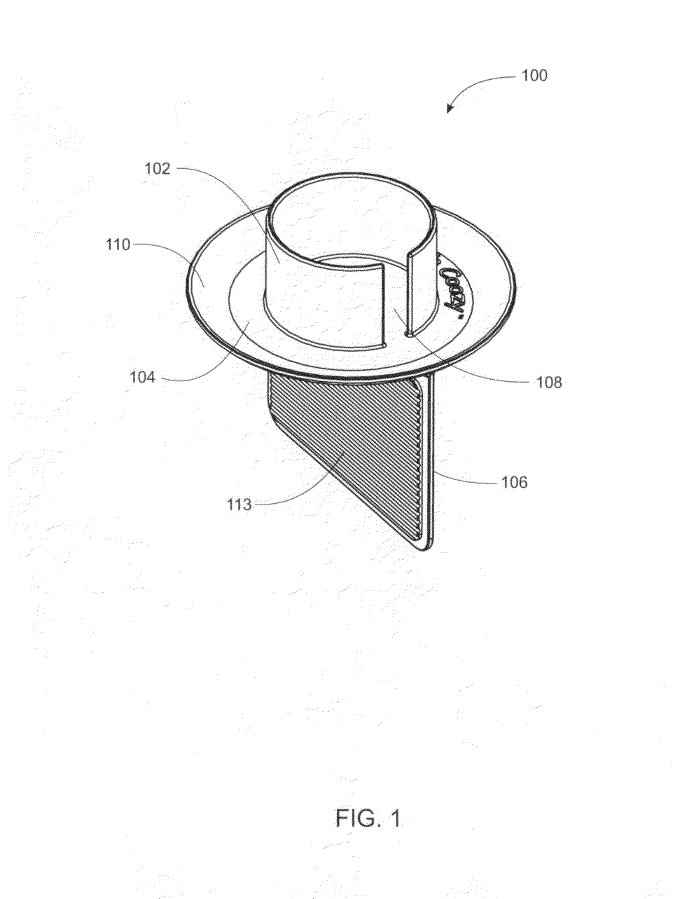

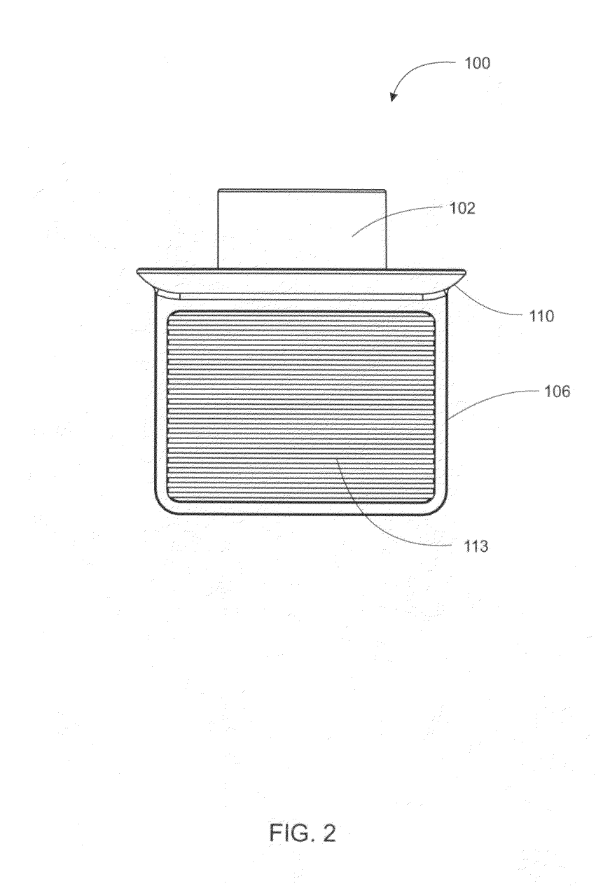

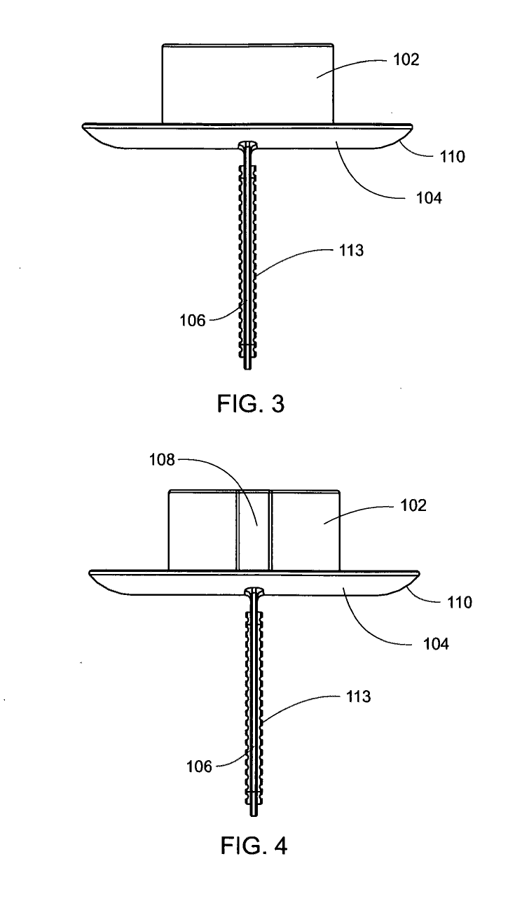

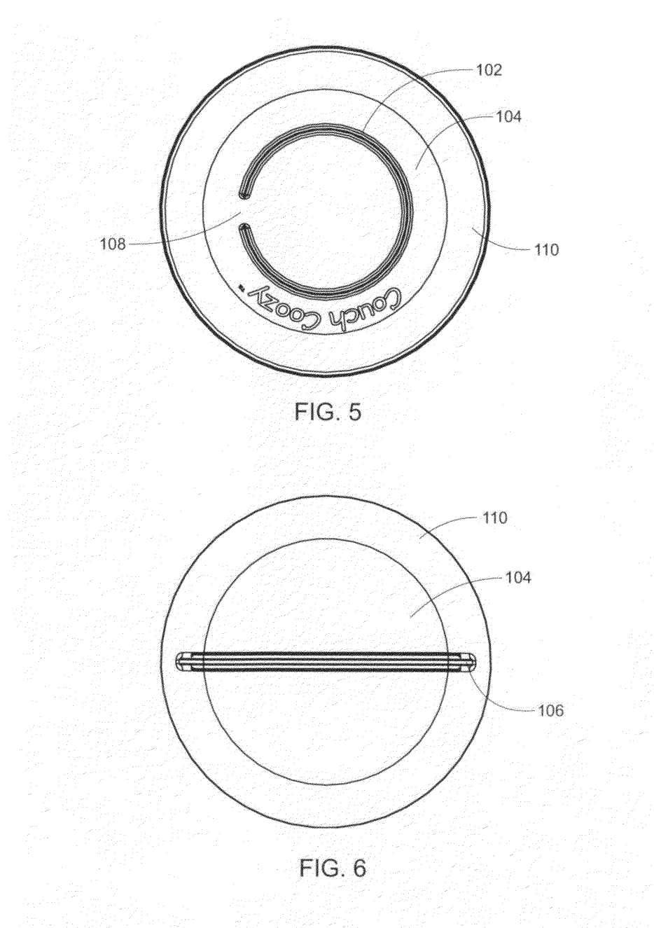

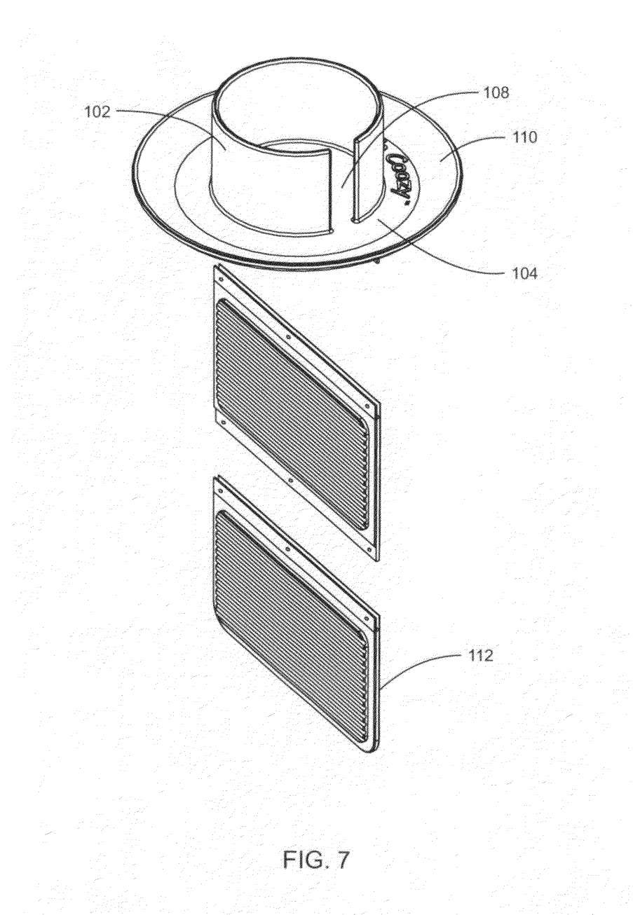

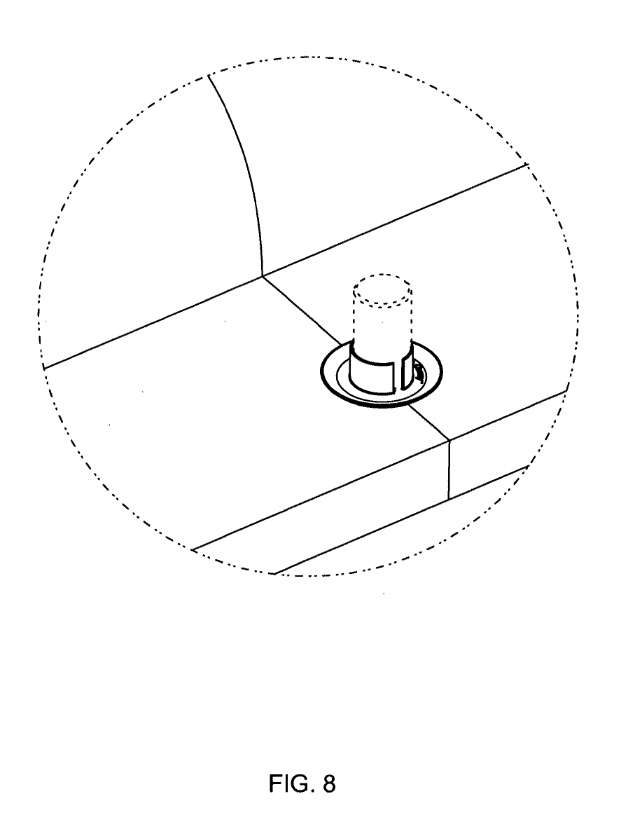

Referring to FIGS. 1-8, an exemplary embodiment of the invention consists of a holding device 100 comprising a holder 102, a tray 104, and a stabilizing member 106 extending downward from the holder and tray. Holding device 100 and its components may be constructed of a rigid polymer, or any other suitable material including without limitation metal, wood, or wide variety of plastics. Holder 102 may also be formed of an insulating material such as thermoplastic foam to help maintain the temperature of the item placed into it.

The precise shape of the holder 102 can be adapted to hold any particular item. In an exemplary embodiment of the invention, the holder 102 is substantially cylindrical in shape and open at the top such that it is adapted to receive a cup or other beverage container. Holder 102 may include a slot 108 to accommodate a feature of the item to be held, such as the handle of a mug. Holder 102 may also be shaped to hold a wide variety of different types of items, such as books, magazines, portable music players, laptop or tablet computers, remote controls, tools, writing implements, food items, games, etc. Holder 102 may also be designed to directly hold a food product. In an exemplary embodiment, holder 102 is a bowl of suitable size and shape to hold popcorn or other snacks.

In an exemplary embodiment, tray 104 extends outward from holder 102 and includes a turned-up portion 110 that will retain spillage from the holder 102 or from an item placed in the holder 102. In an exemplary embodiment tray 104 is removable or partially removable to allow for placement of the holding device in locations where the tray would be in the way. For example, a section of the tray on one or more sides of the holder can be removed to allow for placement of the holding device 100 near the back of a sofa or adjacent to any vertical surface.

In an exemplary embodiment, stabilizing member 106 is a thin, rigid, substantially planar member extending downward perpendicular to the plane of the bottom of the holder. In use, stabilizing member 106 is placed into a receiving slot or space such as the space between the upholstered cushions on a sofa. Stabilizing member 106 may include surface texturing 113 to provide improved frictional engagement with adjacent materials to prevent slipping. In an exemplary embodiment, stabilizing member 106 extends downward from the bottom surface of the holder approximately two to four inches. Stabilizing member 106 may also include one or more removable extensions 112 for use with receiving slots or spaces of various depths. Removable extensions may include complementary tongue and groove elements for attachment, or may be removably attached to each other and to the holder by any appropriate fastening method.

Stabilizing member 106 may be affixed either directly or indirectly to holder 102 in various orientations or may be adjustable so that its orientation relative to holder 102 can be optimized based on the surface on which it is being placed. In one embodiment, stabilizing member 106 is affixed such that it extends downward from the center of the holder 102, such that its center point is directly below the center of holder 102. Such an orientation would be suitable for insertion between two adjacent upholstered cushions on a typical sofa, such that the holder 102 rests substantially equally on each cushion.

In other embodiments, stabilizing member 106 is offset from the center of the holder. In one exemplary embodiment stabilizing member 106 extends downward from an outer edge of the holder so that it can be placed into a receiving slot or space adjacent to a vertical surface such as the back or arm of a sofa or chair.

Holder 102 may also be designed such that it is removably attached to stabilizing member 106. In an exemplary embodiment, stabilizing member 106 has a flange or other surface at the top that prevents the stabilizing member 106 from sliding down below the surface of the cushions or other objects it is placed between. Holder 102 is removably attached to the flange or other surface such that it can be easily attached and detached. Stabilizing member 106 can then be left in place while holder 102 is removed for filling or cleaning. Holder 102 can then be easily reattached to stabilizing member 106 for use.

What is claimed is:

1. A holding device comprising:
a holder designed to hold a beverage container,
a tray extending laterally outward from the bottom of holder, and
a stabilizing member extending downward from the holder and tray.

2. The device of claim 1, wherein said beverage container is a mug with a handle.

3. The device of claim 1, wherein said beverage container is a soda can.

4. The device of claim 1, wherein said stabilizing member extends downward perpendicular to the plane of the bottom of the holder.

5. The device of claim 1, wherein the surface of said stabilizing member is textured.

6. The device of claim 1, wherein said stabilizing member has removable extensions.

7. The device of claim 1, wherein said stabilizing member extends downward from the middle of the holder.

8. The device of claim 1, wherein said stabilizing member extends downward from one edge of the holder.

9. The device of claim 1, wherein said tray is partially removable.

10. A holding device comprising:
a holder designed to hold one or more objects,
and a stabilizing member extending downward from the holder.

11. The device of claim 10, wherein said object is a beverage container.

12. The device of claim 11, wherein said beverage container is a soda can.

13. The device of claim 10, wherein said stabilizing member extends downward perpendicular to the plane of the bottom of the holder.

14. The device of claim 10, wherein the surface of said stabilizing member is textured.

15. The device of claim 10, wherein said stabilizing member has removable extensions.

16. The device of claim 10, wherein said stabilizing member extends downward from the middle of the holder.

17. The device of claim 10, wherein said stabilizing member extends downward from one edge of the holder.
